(19) United States
(12) Patent Application Publication
(10) Pub. No.: US 2010/0109599 A1
(43) Pub. Date: May 6, 2010

(54) PORTABLE SOLAR CHARGING APPARATUS

(76) Inventors: Kuo-Len Lin, Wugu Township (TW); Chen-Hsiang Lin, Wugu Township (TW); Hwai-Ming Wang, Wugu Township (TW); Ken Hsu, Wugu Township (TW); Chih-Hung Cheng, Wugu Township (TW)

Correspondence Address: HDLS Patent & Trademark Services, P.O. BOX 220746, CHANTILLY, VA, 20153-0746, US

(21) Appl. No.: 12/265,364

(22) Filed: Nov. 5, 2008

(51) Int. Cl. H02J 7/00

(52) U.S. Cl. 320/101

(57) ABSTRACT

A portable solar charging apparatus includes a retaining base, a snoot, a photoelectric conversion module, a power connector and a joint mechanism. The snoot is mounted onto the retaining base, and a containing space is formed between the retaining base and the snoot. The photoelectric conversion module is contained in the containing space and mounted onto the retaining base. The photoelectric conversion module includes an accumulator and a solar chip electrically connected to the accumulator. The solar chip is installed corresponding to the snoot. The power connector is connected to the retaining base and electrically coupled to the accumulator. The joint mechanism is connected to the retaining base and disposed outside the containing space. The invention allows a portable electronic product to be charged and used anytime and improves the overall photoelectric conversion efficiency.

### BACKGROUND OF THE INVENTION

1. Field of the Invention

The present invention generally relates to a solar charging apparatus, and more particularly to a portable solar charging apparatus.

2. Description of Prior Art

At present, the world is facing a serious energy shortage, and people pay more attention to the power saving issue, and a charging apparatus applied in portable electronic products such as mobile phones, personal digital assistants (PDA) or digital cameras for charging the portable electric products by solar chips is gradually replaced by a solar charging apparatus for converting light energy into electric energy, but the photoelectric conversion efficiency of the solar chips available in the market is generally low, and thus it is a subject for the related industry to improve the photoelectric conversion generation efficiency of the solar chips.

In general, a traditional solar charging apparatus includes a retaining base, a snoot, a photoelectric conversion module and a power connector, wherein the snoot is coupled onto the retaining base, and a containing space is defined between the retaining base and the snoot, and the photoelectric conversion module is contained in the containing space and fixed onto the retaining base. The photoelectric conversion module includes a plurality of solar chips and an accumulator electrically coupled to the solar chip, wherein the solar chip is a silicon chip installed corresponding to the snoot, and the power connector is connected to the retaining base and electrically coupled to the accumulator.

Before use, the solar charging apparatus is placed indoors or outdoors with sufficient light, and the light energy received by the solar chip from the outside is converted into electric energy, and the electric energy is stored in the accumulator, such that when the portable electronic product has insufficient or no electric power, the solar charging apparatus will charge the portable electronic product.

However, the traditional solar charging apparatus still has the following drawbacks. If a user does not carry the solar charging apparatus or the solar charging apparatus has not been charged under light before use, then the user cannot charge or use the portable electronic product. Furthermore, the traditional solar charging apparatus is made of a silicon chip whose photoelectric conversion efficiency is poor and approximately equal to 15%.

In view of the foregoing shortcomings of the prior art, the inventor of the present invention based on years of experience in the related industry to conduct extensive researches and experiments, and finally developed a portable solar charging apparatus in accordance with the present invention to overcome the shortcomings of the prior art.

### SUMMARY OF THE INVENTION

It is a primary objective of the present invention to provide a portable solar charging apparatus of an electronic product, wherein the solar charging apparatus comes with a joint mechanism for installing/removing the solar charging apparatus onto/from the portable electronic product, such that the solar charging apparatus can receive and convert external light energy into electric energy anytime and provide the electric energy to the portable electronic product.

Another objective of the present invention is to supply electric power to a portable electronic product, so that the portable electronic product can be charged and used anytime.

To achieve the foregoing objectives, the present invention provides a portable solar charging apparatus comprising a retaining base, a snoot, a photoelectric conversion module, a power connector and a joint mechanism. The snoot is coupled onto the retaining base, and a containing space is formed between the retaining base and the snoot. The photoelectric conversion module is contained in the containing space and fixed onto the retaining base, and the photoelectric conversion module includes an accumulator and a solar chip electrically coupled to the accumulator, and the solar chip is installed corresponding to the snoot. The power connector is connected to the retaining base and electrically coupled to the accumulator, and the joint mechanism is coupled to the retaining base and disposed outside the containing space.

Another objective of the present invention is to provide a portable solar charging apparatus having a solar chip which is a single-joint gallium arsenide germanium-based (GaAs/Ge) solar chip or a multi-joint (InGaP/GaAs/Ge) solar chip to improve the overall photoelectric conversion efficiency of the solar chip.

### BRIEF DESCRIPTION OF DRAWINGS

FIG. 1 is an exploded view of the present invention;

FIG. 2 is a perspective view of the present invention;

FIG. 3 is a perspective view of the invention applied in a portable electronic product;

FIG. 4 is a perspective view of an assembly of FIG. 3;

FIG. 5 4 is a perspective view of another assembly of FIG. 3;

FIG. 6 is a first schematic view of a first preferred embodiment of the present invention;

FIG. 7 is a schematic view of a second preferred embodiment of the present invention; and

FIG. 8 is a schematic view of a third preferred embodiment of the present invention.

### DETAILED DESCRIPTION OF THE INVENTION

The technical characteristics, features and advantages of the present invention will become apparent in the following detailed description of preferred embodiments with reference to the accompanying drawings, and the preferred embodiments are used for illustrating the present invention only, but not intended to limit the scope of the invention.

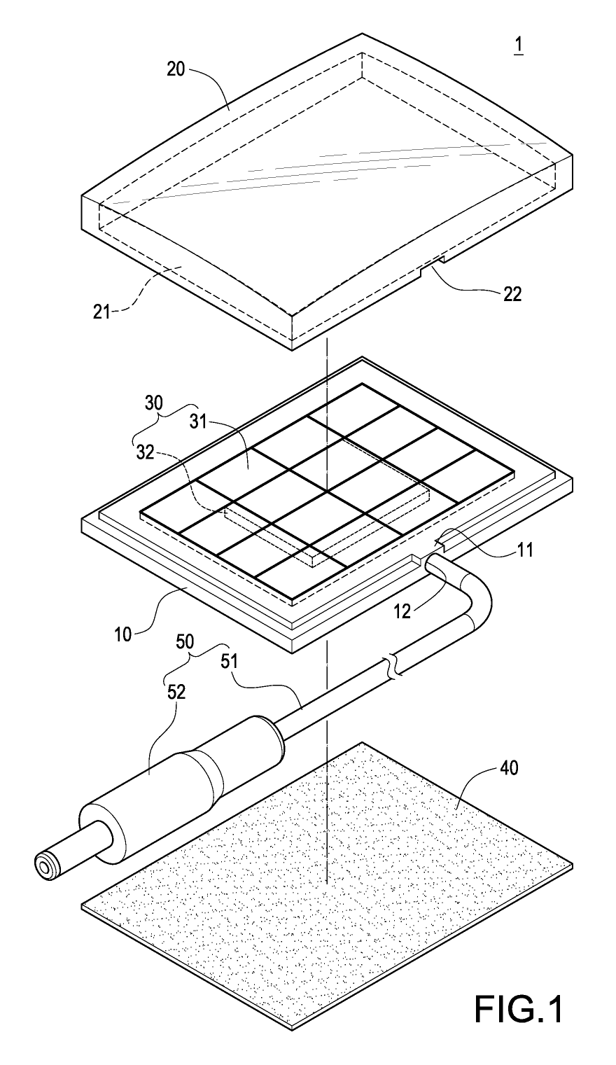

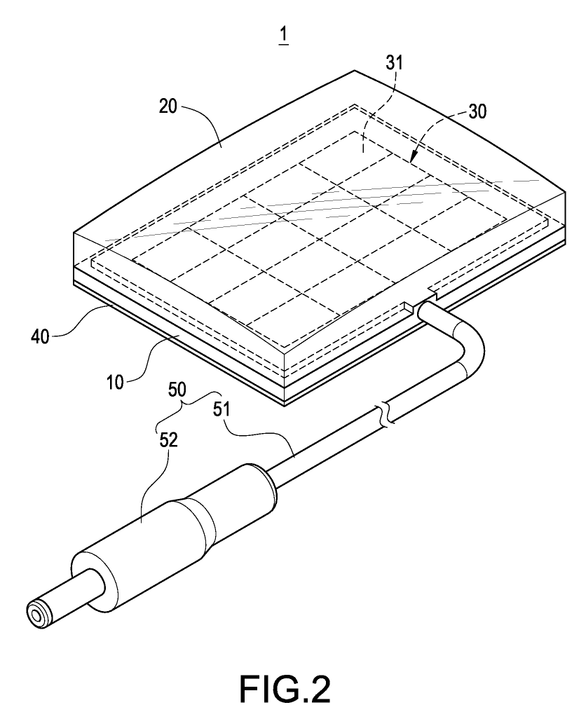

With reference to FIGS. 1 and 2, a portable solar charging apparatus 1 of the invention comprises a retaining base 10, a snoot 20, a photoelectric conversion module 30, a joint mechanism 40 and a power connector 50.

The retaining base 10 is a rectangular base having a latch bar 11 formed at an external periphery of the retaining base 10 and a wire outlet hole 12, wherein the retaining base 10 is made of metal, plastic or a high temperature resisting and insulating material.

The snoot 20 is coupled to the retaining base 10 and includes a containing space 21 between the retaining base 10 and the snoot 20, wherein the snoot 20 includes a latch slot 22 latched at a position corresponding to the latch bar 11, and the wire outlet hole 12 is interconnected with the containing space 21, and the snoot 20 is provided for focusing a light source to increase the effective area of a light projection, and the snoot 20 is a general lens.

The photoelectric conversion module 30 is contained in the containing space 21 and mounted onto the top of the retaining base 10, and the photoelectric conversion module 30 includes a plurality of solar chips 31 connected in parallel or in series with each other and electrically coupled to an accumulator 32 of the solar chip 31. The solar chips 31 are installed corresponding to the snoot 20 for receiving an external light source and converting light energy into electric energy. The accumulator 32 stores the electric energy converted by the solar chips 31, wherein the solar chips 31 are single-joint gallium arsenide germanium-based (GaAs/Ge) solar chips or multi-joint indium gallium phosphide/gallium arsenide/germanium (InGaP/GaAs/Ge) solar chips, and the accumulator 32 is a lithium cell, a polymer lithium cell, a lithium-ion cell, a nickel-hydrogen cell or a nickel-cadmium cell.

The joint mechanism 40 is connected to the bottom of the retaining base 10 and disposed outside the containing space 21, and the joint mechanism 40 of this embodiment is an adhesive.

The power connector 50 is connected to the retaining base 10 and electrically coupled to the accumulator 32, and the power connector 50 includes an electric wire 51 passed out from the wire outlet hole 12 and electrically coupled to the accumulator 32 and a connector 52 electrically coupled to the electric wire 51, wherein the connector 52 is a circular connector.

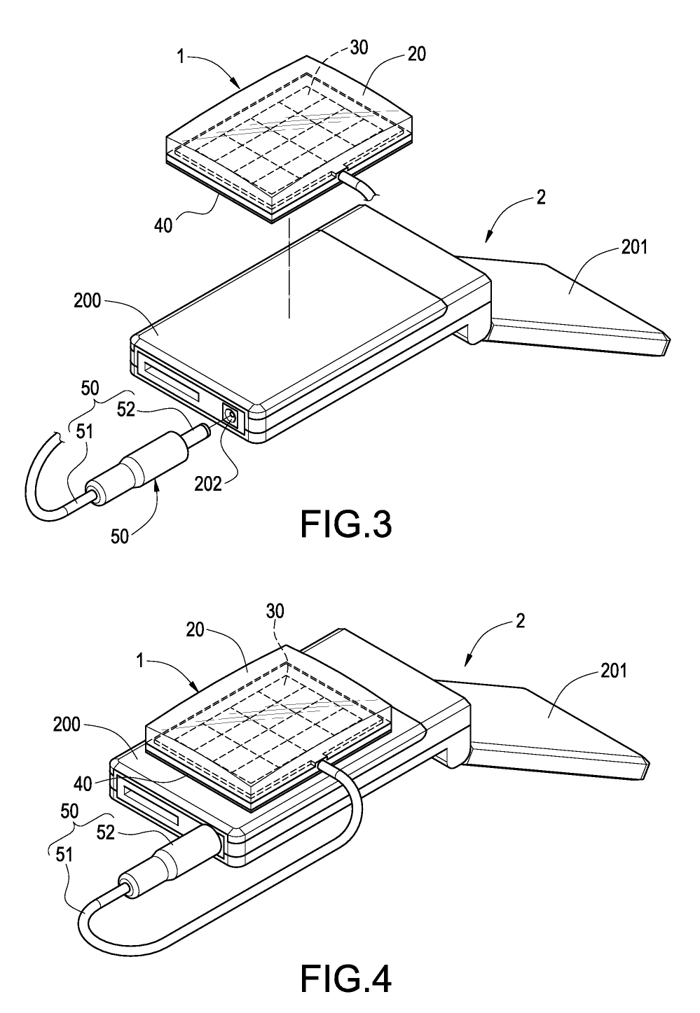

After the aforementioned components are assembled, a smaller and thinner portable solar charging apparatus 1 of the invention is produced, and the portable solar charging apparatus 1 can be mounted onto a portable electronic product 2 (as shown in FIGS. 3 and 4), and the portable electronic product 2 can be a mobile phone having a body 200 and a clamshell cover 201 connected to the body 200, and the body 200 includes a charging socket 202, and the joint mechanism 40 (or an adhesive) is used for fixing the backside of the body 200, and then the connector 52 of the power connector 50 is inserted into the charging socket 202, such that the solar chips 31 can receive external light energy and supply electric power to the portable electronic product 2 and allow the portable electronic product 2 to be charged or used anytime.

Since the solar chips 31 of the invention area single-joint gallium arsenide germanium-based (GaAs/Ge) solar chips or multi-joint indium gallium phosphide/gallium arsenide/germanium (InGaP/GaAs/Ge) solar chips, therefore the photoelectric conversion efficiency are greater than 18% or 30% respectively, and the overall photoelectric conversion efficiency is enhanced.

The foregoing portable electronic product 2 includes but not limited to a mobile phone, a personal digital assistant (PDA), a digital camera, an iPhone or an iPod.

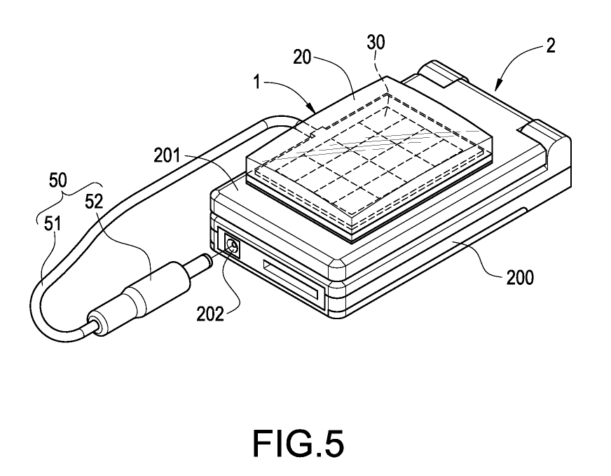

With reference to FIG. 5, the portable solar charging apparatus 1 of the invention can be fixed onto the clamshell cover 201 of the portable electronic product 2, and this is another way of fixing the solar charging apparatus 1.

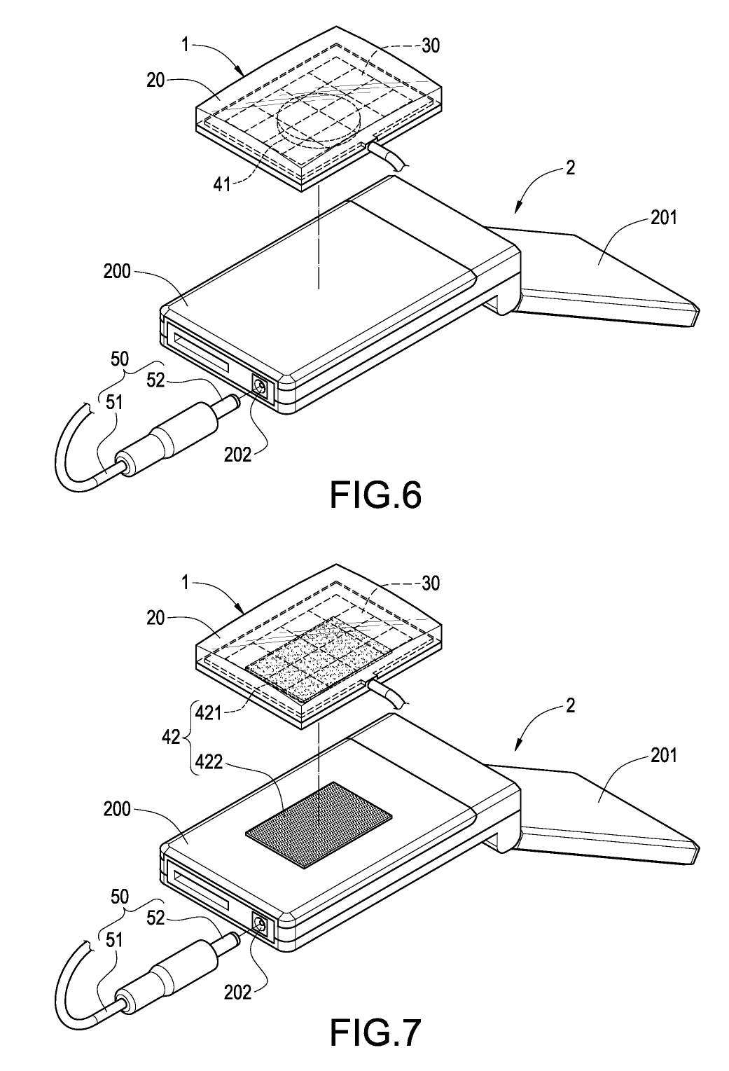

With reference to FIG. 6 for another preferred embodiment of the present invention, the difference of this embodiment from the previous one resides on that the joint mechanism 40 is a magnet 41, and a casing of the body 200 of the portable electronic product 2 is made of iron, or an iron piece is installed in the body 200, such that the magnet 41 can attract the iron material or the iron piece. In addition, an iron piece can be installed in the clamshell cover 201 or the casing of the clamshell cover 201 made of iron, such that the solar charging apparatus 1 can be attached onto the clamshell cover 201.

With reference to FIG. 7 for a further preferred embodiment of the present invention, the difference of this embodiment from the previous one resides on that the joint mechanism 40 is a loop side 421 of a Velcro tape 42 and the body 200 of the portable electronic product 2 has a hook side 422 of the Velcro tape 42, and the loop side 421 is attached to the corresponding hook side 422. In addition, the hook side 422 of the Velcro tape 42 is set on the clamshell cover 201 for attaching the portable solar charging apparatus onto the clamshell cover 201.

It is noteworthy to point out that the joint mechanism 40 can be a hook side 422 of the Velcro tape 42, and the body 200 or the clamshell cover 201 of the portable electronic product 2 can have the loop side 421 of the Velcro tape 42 for attaching the corresponding components.

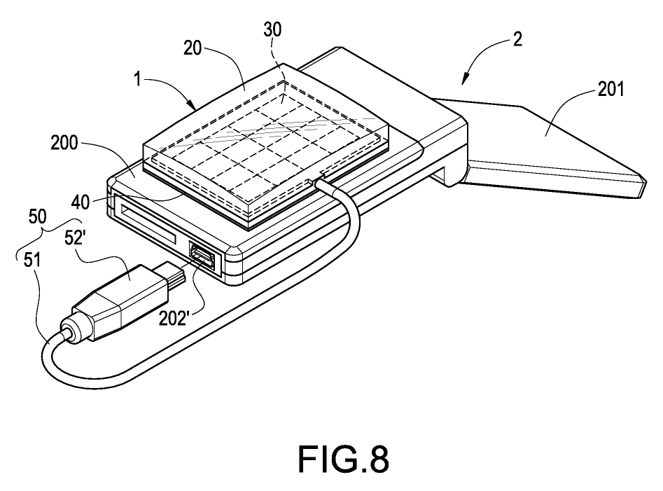

With reference to FIG. 8 for a further preferred embodiment of the present invention, the difference of this embodiment from the previous one resides on that the connector 52 of the power connector 50 is a USB connector 52′, and the charging socket 202 of the portable electronic product 2 is a USB charging socket 202′ provided for receiving the corresponding USB connector 52′.

In summation of the description above, the portable electronic product 2 can be charged and used anytime, and the overall photoelectric conversion efficiency can be improved, and thus the invention complies with patent application requirements, and is duly filed for patent application.

While the invention has been described by means of specific embodiments, numerous modifications and variations could be made thereto by those skilled in the art without departing from the scope and spirit of the invention set forth in the claims.

What is claimed is:

1. A solar charging apparatus, comprising:
a retaining base;
a snoot, coupled onto the retaining base, such that a containing space is defined between the retaining base and the snoot;
a photoelectric conversion module, contained in the containing space and fixed onto the retaining base, and the photoelectric conversion module having an accumulator and a solar chip electrically coupled to the accumulator and installed corresponding to the snoot;
a power connector, connected to the retaining base and electrically coupled to the accumulator; and
a joint mechanism, coupled to the retaining base and disposed outside the containing space.

2. The portable solar charging apparatus of claim 1, wherein the solar chip is a single-joint gallium arsenide germanium-based (GaAs/Ge) solar chip.

3. The portable solar charging apparatus of claim 1, wherein the solar chip is a multi-joint indium gallium phosphide/gallium arsenide/germanium (InGaP/GaAs/Ge) solar chip.

4. The portable solar charging apparatus of claim 1, wherein the joint mechanism is an adhesive.

5. The portable solar charging apparatus of claim 1, wherein the joint mechanism is a magnet.

6. The portable solar charging apparatus of claim 1, wherein the joint mechanism is a Velcro tape.

7. The portable solar charging apparatus of claim 1, wherein the retaining base has a latch bar, and the snoot has a latch slot for latching the corresponding latch bar.

8. The portable solar charging apparatus of claim 1, wherein the accumulator is a lithium cell, a polymer lithium cell, a lithium-ion cell, a nickel-hydrogen cell or a nickel-cadmium cell.

9. The portable solar charging apparatus of claim 1, wherein the power connector includes an electric wire coupled to the accumulator and a connector electrically coupled to the electric wire.

10. The portable solar charging apparatus of claim 9, wherein the connector is a USB connector.
